(19) United States
(12) Patent Application Publication
(10) Pub. No.: US 2007/0143342 A1
(43) Pub. Date: Jun. 21, 2007

(54) Destination based extraction of XML clinical data

(76) Inventor: S. Lance VanNostrand, Plano, TX (US)

Correspondence Address: Pamela R. Crocker;Patent Legal Staff, Eastman Kodak Company, 343 State Street, Rochester, NY, 14650-2201, US

(21) Appl. No.: 11/313,379

(22) Filed: Dec. 21, 2005

(51) Int. Cl. G06F 17/00

(52) U.S. Cl. 707/104.1

(57) ABSTRACT

Destination based extraction of XML clinical data. A system includes a validation module, an extraction module, and a translation module. The validation module is configured to receive Extensible Markup Language (XML) clinical data and validate the XML clinical data. The extraction module is configured to extract data from the XML clinical data based on destination capabilities. The translation module is configured to translate the extracted data to conform to a non-XML standard.

### FIELD OF THE INVENTION

The present invention relates generally to XML clinical data processing, and more specifically to an XML clinical data processing system including destination based extraction of XML clinical data for generating non-XML standard conformant data messages.

### BACKGROUND OF THE INVENTION

Extensible Markup Language (XML) is widely used for representing information. XML is capable of describing many different kinds of data. Describing data using XML facilitates the sharing of the data across different types of systems. Medical devices that manage clinical information may represent that clinical information model using XML. The XML representation of the clinical information allows medical and non-medical applications to process the data and/or transform the data into other representations that are more easily interfaced with specialized subsystems. When clinical data is passed over communication channels between devices for purposes of storage or processing, two popular standards for representing the data include Digital Imaging and Communications in Medicine (DICOM) and Health Level 7 (HL7). For purposes of this description, the term standardized refers to DICOM data, HL7 data, or other suitable standard conformant data.

XML files can be tested to determine whether they contain data in a specific format used by a specific device by applying an XML schema to the XML file. An XML schema defines rigid rules for the relationships between data elements within the XML file. The XML schema is used to validate the XML file to ensure that the XML file matches the rules that the application is expecting.

Medical devices that use DICOM, HL7, or other standards for network communications produce conformant messages that contain attributes having valid information for all required message content. Required and optional content for standardized messages is defined by standard information models. A medical device is typically designed with the ability to communicate using at least one standard.

Medical information is easily managed and handled using an XML data model, but many typical medical devices use DICOM, HL7, or other standardized data models for consuming or processing data. To use XML with these medical devices that receive and process only standardized data, the XML data is translated to the standard format. Translating the XML data to the standard format includes ensuring that all optional and required attributes are included in the translation and that the attributes are translated correctly. Typical translation processes cannot generate standardized data from the XML data for multiple destinations.

As such, there is a need for a data processing system for extracting XML data based on the destination for the data for generating standardized data for the destination.

### SUMMARY OF THE INVENTION

One embodiment of the present invention provides a system that includes a validation module, an extraction module, and a translation module. The validation module is configured to receive Extensible Markup Language (XML) clinical data and validate the XML clinical data. The extraction module is configured to extract data from the XML clinical data based on destination capabilities. The translation module is configured to translate the extracted data to conform to a non-XML standard.

Embodiments of the invention provide an XML clinical data processing system for extracting XML clinical data from a superset of XML clinical data based on a particular destination or destinations for the clinical data. The extracted XML clinical data is formatted to comply with the messaging format used by the destination or destinations for the message, such as DICOM, HL7, or other suitable message standard. Therefore, a single XML clinical data record can be processed and used by multiple medical devices and applications using different data standards.

### BRIEF DESCRIPTION OF THE DRAWINGS

FIG. 1 is a block diagram illustrating one embodiment of an XML clinical data processing system.

FIG. 2 is a block diagram illustrating one embodiment of a computer system for implementing the XML clinical data processing system.

FIG. 3A is a block diagram illustrating one embodiment of an extraction module.

FIG. 3B is a block diagram illustrating another embodiment of an extraction module.

FIG. 4 is a block diagram illustrating one embodiment of a translation module.

FIG. 5 is a flow diagram illustrating one embodiment of a method for processing XML clinical data.

FIG. 6 is a flow diagram illustrating one embodiment of a method for extracting destination specific XML clinical data.

FIG. 7 is a flow diagram illustrating another embodiment of a method for extracting destination specific XML clinical data.

FIG. 8 illustrates one embodiment of a portion of an XML clinical data file including non-DICOM data elements.

FIG. 9 illustrates one embodiment of a portion of a standard equivalent XML clinical data file after extraction of data from the XML clinical data file.

### DETAILED DESCRIPTION OF THE INVENTION

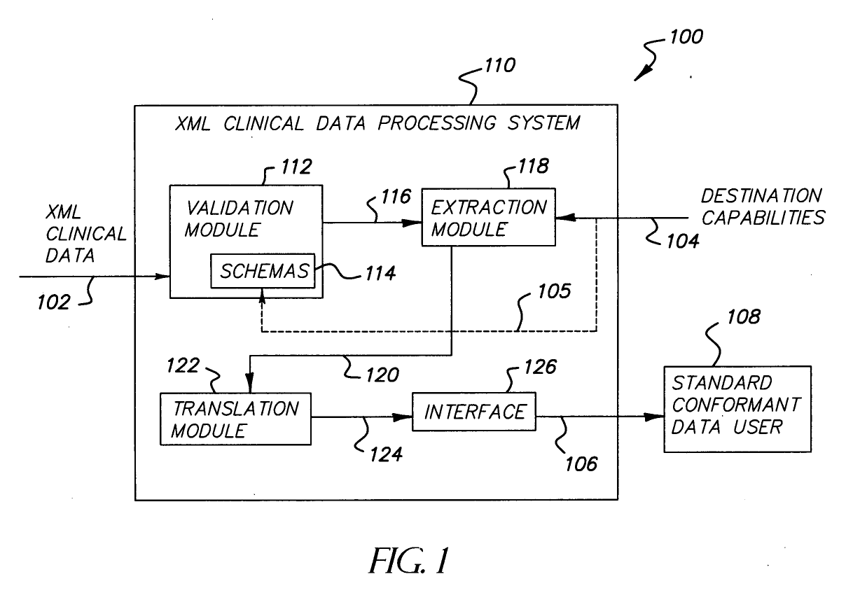

FIG. 1 is a block diagram illustrating one embodiment of an XML clinical data processing system 100. XML clinical data processing system 100 includes processing module 110. Processing module 110 receives XML clinical data on XML clinical data communication path 102. Processing module 110 receives destination capabilities on destination capabilities communication path 104. Processing module 110 provides non-XML standard clinical data, such as DICOM or HL7 conformant data to a standard conformant data user 108 through communication path 106.

Processing module 110 includes validation module 112 including schemas 114, extraction module 118, translation module 122, and interface 126. Validation module 112 receives the XML clinical data on communication path 102. XML clinical data includes patient information, medical history, test results, studies, or other suitable medical data. Validation module 112 validates the XML clinical data based on XML schemas 114. XML schemas 114 are preselected or optionally selected based on destination capabilities passed from communication path 104 to communication path 105. Validation module 112 outputs validated XML clinical data to extraction module 118 through validated XML clinical data communication path 116.

Extraction module 118 receives the validated XML clinical data and based on the destination capabilities received on communication path 104 extracts destination specific data from the XML clinical data. The destination capabilities include information such as whether the destination uses DICOM conformant data, HL7 conformant data, or other standard conformant data, which data elements the destination uses, or any other suitable information describing the capabilities of the destination. Extraction module 118 outputs standard equivalent XML clinical data including the destination specific data elements on standard equivalent XML clinical data communication path 120.

Translation module 122 receives the standard equivalent XML clinical data and translates the standard equivalent XML clinical data to provide non-XML standard clinical data based on the standard equivalent XML clinical data. Translation module 122 translates the standard equivalent XML clinical data to DICOM, HL7, or other suitable non-XML standard. Translation module 122 outputs the non-XML standard clinical data on communication path 124.

Interface 126 receives the non-XML standard clinical data and outputs the non-XML standard clinical data to standard conformant data user 108 through communication path 106. Standard conformant data user 108 can include a medical device, a computer application, a data storage system, or other suitable data user.

FIG. 2 is a block diagram illustrating one embodiment of a computer system 150 for implementing XML clinical data processing system 100. Computer system 150 includes a processor 152, a memory 154, a user interface 162, and a clinical data interface 164. Memory 154 includes a read only memory (ROM) 156, a random access memory (RAM) 158, and an application/data memory 160.

Computer system 150 executes an application program for implementing XML clinical data processing system 100. The application program is loaded from application/data memory 160 or any other computer readable medium. Processor 152 executes commands and instructions for implementing XML clinical data processing system 100. In one embodiment, ROM 156 stores the operating system for computer system 150, and RAM 159 temporarily stores application data and instructions for implementing XML clinical data processing system 100.

User interface 162 provides an interface to computer system 150 for users to operate XML clinical data processing system 100. In one embodiment, user interface 162 includes a keyboard, a monitor, a mouse, and/or any other suitable input or output device. Clinical data interface 164 receives XML clinical data and provides non-XML standard clinical data through communication link 166. In one embodiment, communication link 166 includes XML clinical data communication path 102 and communication path 106 of XML clinical data processing system 100 illustrated in FIG. 1.

Memory 154 can include main memory, such as a random access memory (RAM) 158, or other dynamic storage device. Memory 154 can also include a static storage device for application/data memory 160, such as a magnetic disk or optical disk. Memory 154 stores information and instructions to be executed by processor 152. In addition, memory 154 stores data for XML clinical data processing system 100. One or more processors in a multi-processor arrangement can also be employed to execute a sequence of instructions contained in memory 154. In other embodiments, hardwired circuitry can be used in place of or in combination with software instructions to implement XML clinical data processing system 100. Thus, embodiments of XML clinical data processing system 100 are not limited to any specific combination of hardware circuitry and software.

The term “computer readable medium,” as used herein, refers to any medium that participates in providing instructions to processor 152 for execution. Such a medium can take many forms, including but not limited to, non-volatile media, volatile media, and transmission media. Non-volatile media include, for example, optical or magnetic disks. Volatile media includes dynamic memory. Transmission media include coaxial cables, copper wire, and fiber optics. Transmission media can also take the form of acoustic or light waves, such as those generated during radio frequency (RF) and infrared (IR) data communications. Common forms of computer readable media include, for example, a floppy disk, a flexible disk, a hard disk, magnetic tape, any other magnetic mediums, a CD-ROM, DVD, any other optical medium, punch cards, paper tape, any other physical medium with patterns of holes, a RAM, a programmable read-only memory (PROM), an electrically programmable read-only memory (EPROM), an electrically erasable programmable read-only memory (EEPROM), any other memory chip or cartridge, or any other medium from which a computer can read.

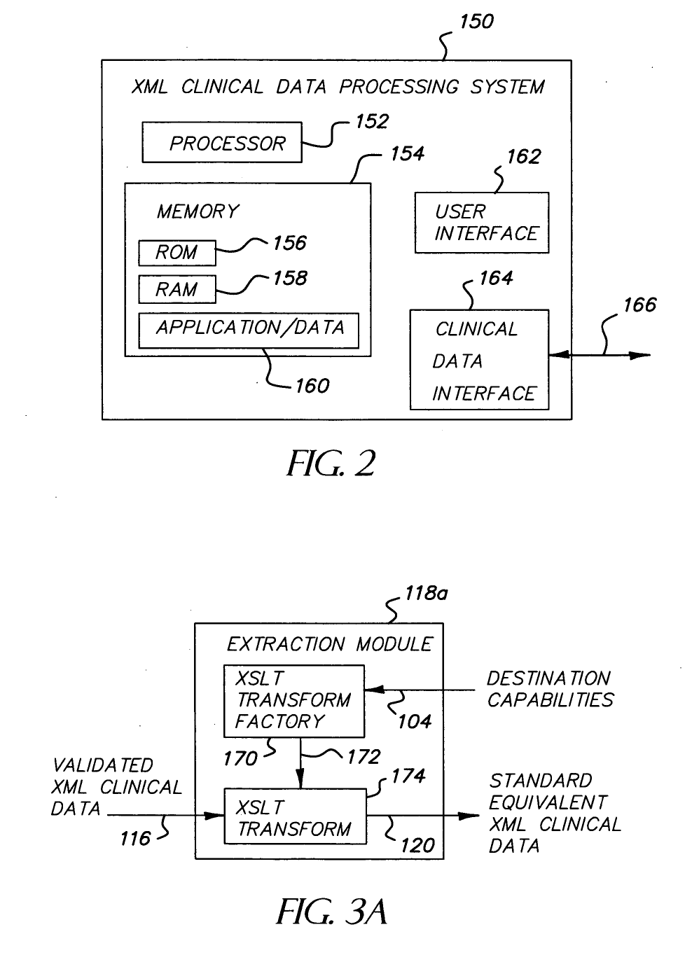

FIG. 3A is a block diagram illustrating one embodiment of an extraction module 118a. In one embodiment, extraction module 118 (FIG. 1) is similar to extraction module 118a. Extraction module 118a includes Extensible Stylesheet Language Transformation (XLST) transform factory 170 and XLST transform block 174. XLST is an XML based language used to transform XML documents. A new XML document is created based on the content of an existing document. XLST transform factory 170 receives destination capabilities on destination capabilities communication path 104. XLST transform factory 170 selects or generates an XLST transform based on the destination capabilities. The XSLT transform provides the information used for extracting data elements from the validated XML clinical data to generate the standard equivalent XML clinical data based on the destination. XLST transform factory 170 passes the XLST transform to XLST transform block 174 through communication path 172.

XLST transform block 174 receives validated XML clinical data on communication path 116. XLST transform block 174 processes the validated XML clinical data using the XLST transform to transform the validated XML clinical data to standard equivalent XML clinical data. XLST transform block 174 outputs the standard equivalent XML clinical data on communication path 120. The standard equivalent XML clinical data includes the XML clinical data elements expected by the specified destination or destinations. The standard equivalent XML clinical data is formatted in such a way that the standard equivalent XML clinical data is accepted as input to translation module 122.

FIG. 3B is a block diagram illustrating another embodiment of an extraction module 118b. In one embodiment, extraction module 118 (FIG. 1) is similar to extraction module 118b. Extraction module 118b includes database 180 and Structured Query Language (SQL) transform block 184. Database 180 receives destination capabilities on destination capabilities communication path 104. Using the destination capabilities, database 180 is queried to select a list of data elements for the specified destination or destinations. The list of selected data elements is passed to SQL transform block 184 through communication path 182.

SQL transform block 184 receives validated XML clinical data on communication path 116. Based on the list of selected data elements received from database 180, SQL transform block 184 extracts the selected data elements from the validated XML clinical data 116 to generate standard equivalent XML clinical data. SQL transform block 184 outputs the standard equivalent XML clinical data on communication path 120. The standard equivalent XML clinical data includes the XML clinical data elements expected by the specified destination or destinations. The standard equivalent XML clinical data is formatted in such a way that the standard equivalent XML clinical data is accepted as input to translation module 122.

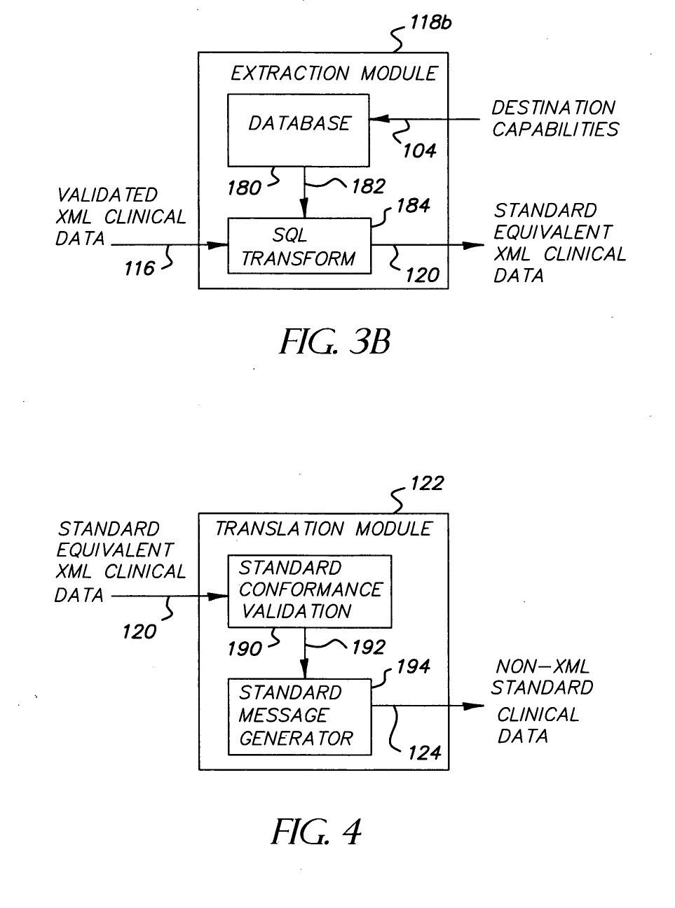

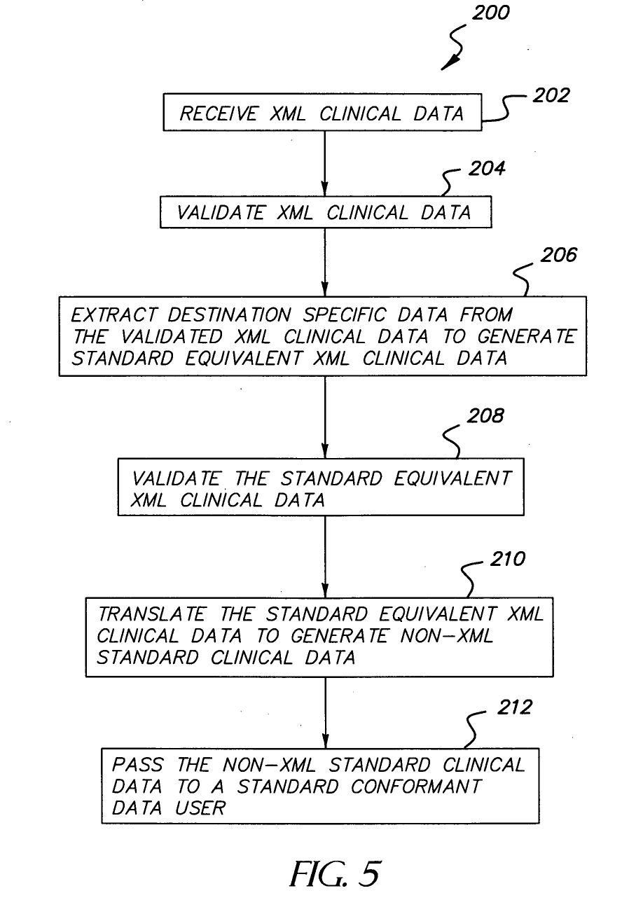

FIG. 4 is a block diagram illustrating one embodiment of translation module 122. Translation module 122 includes standard conformance validation block 190 and standard message generator block 194. Standard conformance validation block 190 receives the standard equivalent XML clinical data from extraction module 118 on communication path 120. Standard conformance validation block 190 validates the standard equivalent XML clinical data using an XML schema or other suitable technique. Standard conformance validation block 190 passes the validated standard equivalent XML clinical data to standard message generator block 194 through communication path 192.

Standard message generator block 194 translates the validated standard equivalent XML clinical data to non-XML standard clinical data, such as DICOM, HL7, or other suitable non-XML standard. Standard message generator block 194 outputs the non-XML standard clinical data on communication path 124. The non-XML standard clinical data is formatted such that the non-XML standard clinical data is accepted as input to standard conformant data user 108.

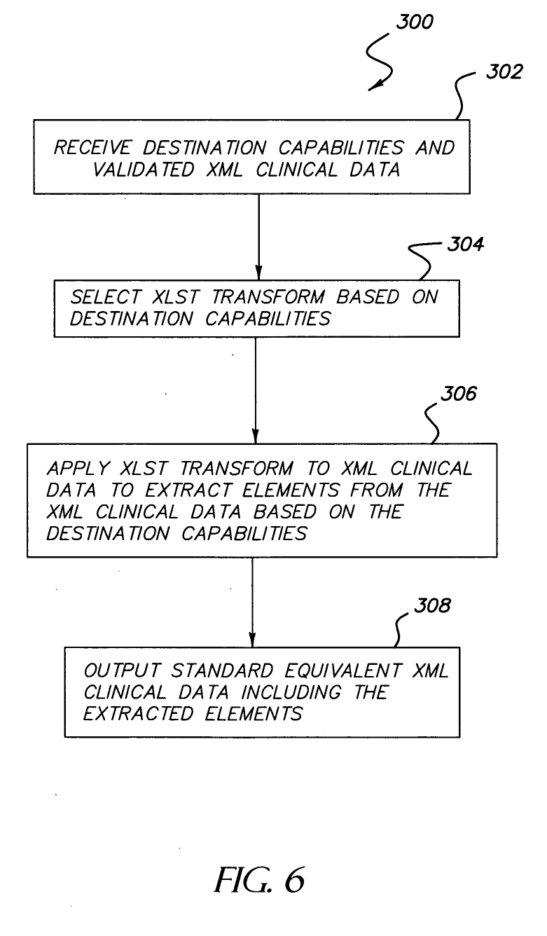

FIG. 5 is a flow diagram 200 illustrating one embodiment of a method for processing XML clinical data. At 202, XML clinical data is received by XML clinical data processing system 110 through communication path 102. At 204, the XML clinical data is validated by validation module 112 using XML schemas 114 or another suitable method. In one embodiment, the validation is based on the destination capabilities. At 206, extraction module 118 extracts destination specific data from the validated XML clinical data to generate standard equivalent XML clinical data. In one embodiment, the destination specific data extraction is performed using an XLST transform as previously described and illustrated with reference to FIG. 3A. In another embodiment, the destination specific data extraction is performed using a database method as previously described and illustrated with reference to FIG. 3B.

At 208, translation module 122 validates the standard equivalent XML clinical data to ensure the standard equivalent XML clinical data is properly formatted for translation. At 210, translation module 122 translates the validated standard equivalent XML clinical data to generate non-XML standard clinical data. In one embodiment, the non-XML standard clinical data is DICOM conformant clinical data. In another embodiment, the non-XML standard clinical data is HL7 conformant clinical data. In other embodiments, the non-XML standard clinical data is other suitable non-XML standard conformant clinical data. At 212, the non-XML standard clinical data is passed to a standard conformant data user 108 through interface 126

FIG. 6 is a flow diagram 300 illustrating one embodiment of extracting destination specific clinical data from XML clinical data. At 302, extraction module 118a including XLST transform factory 170 receives destination capabilities, and XLST transform block 174 receives validated XML clinical data. At 304, XLST transform factory 170 selects an XSLT transform based on the destination capabilities. In one embodiment, XSLT transform factory 170 generates an XSLT transform based on the destination capabilities. At 306, XLST transform block 174 applies the XLST transform to the validated XML clinical data to extract elements from the XML clinical data based on the destination capabilities. At 308, XLST transform block 174 outputs standard equivalent XML clinical data including the extracted elements.

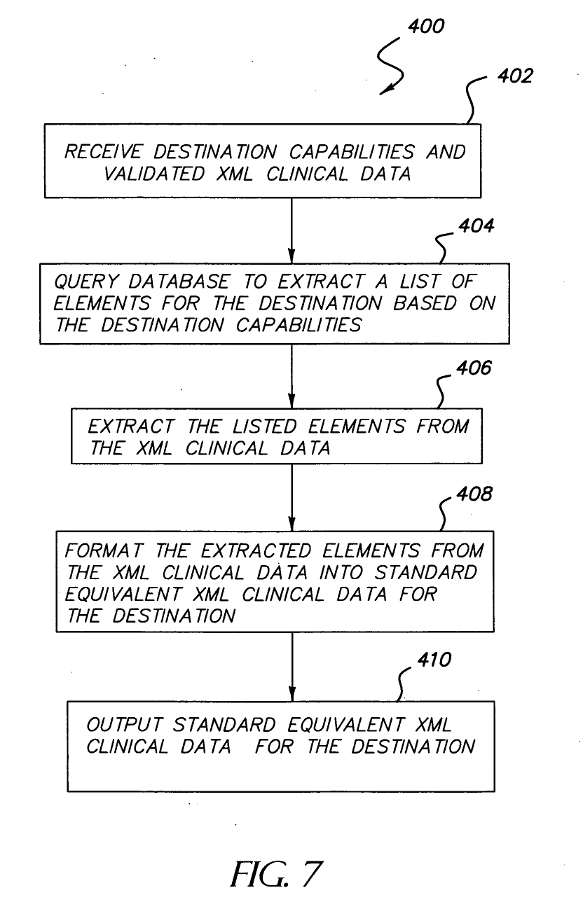

FIG. 7 is a flow diagram 400 illustrating another embodiment of extracting destination specific XML clinical data. At 402, extraction module 118b including database 180 receives destination capabilities, and SQL transform block 184 receives validated XML clinical data. At 404, database 180 is queried based on the destination capabilities to select a list of data elements for the destination. At 406, SQL transform block 184 extracts the selected data elements from the XML clinical data. At 408, SQL transform block 184 formats the extracted data elements from the XML clinical data into standard equivalent XML clinical data based on the destination capabilities. At 410, SQL transform block 184 outputs the standard equivalent XML clinical data including the extracted data elements.

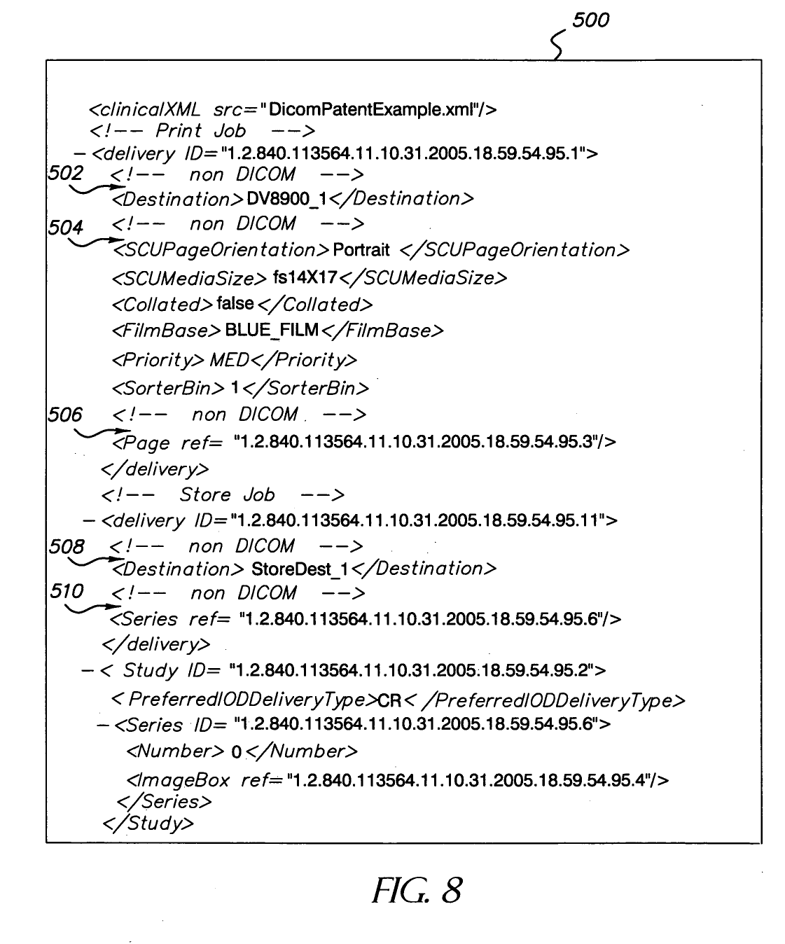

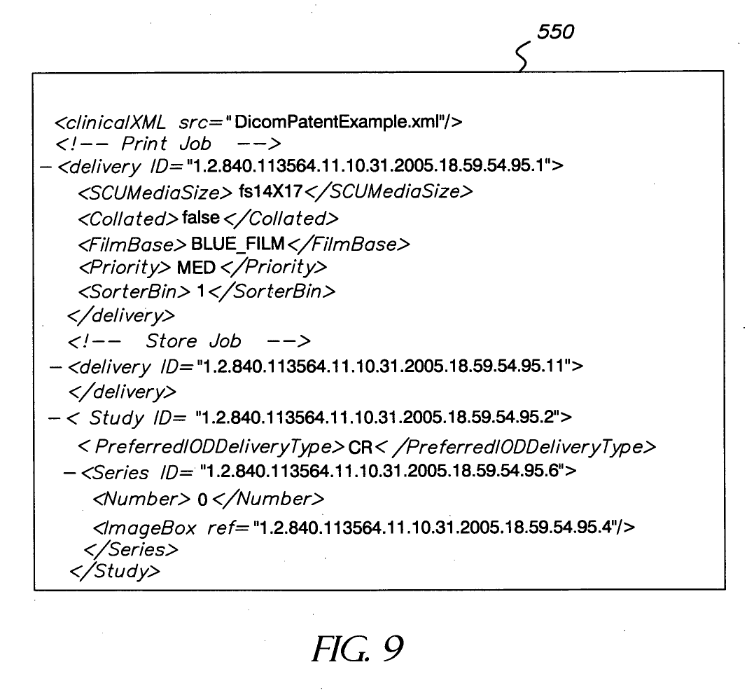

FIG. 8 illustrates one embodiment of a portion of an XML clinical data file 500. XML clinical data file portion 500 includes non-DICOM elements 502, 504, 506, 508, and 510. In one embodiment, XML clinical data includes more than one XML file. As an example, XML clinical data file portion 500 is received by XML clinical data processing module 110 and validated by validation module 112 using an XML schema 114. Validation module 112 determines that XML clinical data file portion 500 is valid and passes the XML clinical data file portion 500 to extraction module 118. Extraction module 118 receives destination capabilities including that the destination uses DICOM conformant clinical data. Extraction module 118 extracts the DICOM elements from the XML clinical data file portion 500.

FIG. 9 illustrates one embodiment of a portion of a standard equivalent XML clinical data file 550 after extracting the DICOM elements from XML clinical data file portion 500. Standard equivalent XML clinical data file portion 550 does not include non-DICOM elements 502, 504, 506, 508, and 510. Extraction module 118 passes the standard equivalent XML clinical data file portion 550 to translation module 122. Translation module 122 translates the standard equivalent XML clinical data file portion 550 to DICOM conformant clinical data and passes the DICOM conformant clinical data to interface 126. Interface 126 passes the DICOM conformant clinical data to a medical device or application that uses DICOM conformant clinical data.

Embodiments of the present invention provide an XML clinical data processing system for extracting XML clinical data from a superset of XML clinical data based on a particular destination or destinations for the clinical data. The extracted XML clinical data is formatted to comply with the messaging format used by the destination or destinations for the message, such as DICOM, HL7, or other suitable message standard. Therefore, a single XML clinical data record can be processed and used by multiple medical devices and applications using different data standards.

The invention has been described in detail with particular reference to certain preferred embodiments thereof, but it will be understood that variations and modifications can be effected within the spirit and scope of the invention.

### PARTS LIST

100 XML Clinical Data Processing System
102 XML Clinical Data Communication Path
104 Destination Capabilities Communication Path
105 Destination Capabilities Communication Path
106 Communication Path
108 Standard Conformant Data User
110 Processing Module
112 Validation Module
114 Schemas
116 Validated XML Clinical Data Communication Path
118 Extraction Module
118a-118b Extraction Module
120 Standard Equivalent XML Clinical Data Communication Path
122 Translation Module
124 Non-XML Standard Clinical Data Communication Path
126 Interface
150 Computer System
152 Processor
154 Memory
156 ROM
158 RAM
160 Application/Data Memory
162 User Interface
164 Clinical Data Interface
166 Communication Link
170 XSLT Transform Factory
172 Communication Path
174 XLST Transform Block
180 Database
182 Communication Path
184 SQL Transform Block
190 Standard Conformance Validation Block
192 Communication Path
194 Standard Message Generator
200 Process Flow Diagram
202-212 Process Procedures
300 Extraction Process Flow Diagram
302-308 Extraction Process Procedures
400 Extraction Process Flow Diagram
402-410 Extraction Process Procedures
500 XML Clinical Data File Portion
502-510 Non-DICOM data
550 Standard Equivalent XML Clinical Data File Portion

What is claimed is:

1. A system comprising:
a validation module configured to receive Extensible Markup Language (XML) clinical data and validate the XML clinical data;
an extraction module configured to extract data from the XML clinical data based on destination capabilities; and
a translation module configured to translate the extracted data to conform to a non-XML standard.

2. The system of claim 1, wherein the extraction module is configured to extract data from the XML clinical data based on destination capabilities to generate standard equivalent XML clinical data, and
wherein the translation module is configured to translate the standard equivalent XML clinical data to conform to the non-XML standard.

3. The system of claim 2, wherein the extraction module comprises an Extensible Stylesheet Language Transform (XLST) based on the destination capabilities to translate the XML clinical data to the standard equivalent XML clinical data.

4. The system of claim 1, wherein the extraction module comprises a database that provides a list of elements to extract from the XML clinical data based on the destination capabilities.

5. The system of claim 1, wherein the non-XML standard comprises a Digital Imaging and Communications in Medicine (DICOM) standard.

6. The system of claim 1, wherein the non-XML standard comprises a Health Level Seven (HL7) standard.

7. The system of claim 1, wherein the validation module is configured to validate the XML clinical data using XML schema validation.

8. The system of claim 1, further comprising an interface configured to pass the non-XML standard data to a conformant data user.

9. A system comprising:
means for validating an Extensible Markup Language (XML) clinical data file;
means for extracting data from the XML clinical data file based on destination capabilities; and
means for translating the extracted data to conform to a non-XML standard.

10. The system of claim 9, wherein the means for extracting comprises means for extracting data from the XML clinical data file based on destination capabilities to generate a standard equivalent XML clinical data file, and
wherein the means for translating comprises means for translating the standard equivalent XML clinical data file to conform to the non-XML standard.

11. The system of claim 10, wherein the means for extracting comprises means for extracting data from the XML clinical data file using an Extensible Stylesheet Language Transform (XLST) based on the destination capabilities.

12. The system of claim 9, wherein the means for extracting comprises means for extracting data from the XML clinical data file based on a list of data elements provided by a database, the list of data elements based on the destination capabilities.

13. The system of claim 9, wherein the non-XML standard comprises a Digital Imaging and Communications in Medicine (DICOM) standard.

14. The system of claim 9, wherein the non-XML standard comprises a Health Level Seven (HL7) standard.

15. The system of claim 9, wherein the means for validating comprises means for validating the XML clinical data file using XML schema validation.

16. The system of claim 9, further comprising means for passing the non-XML standard data to a conformant data user.

17. A method for processing clinical data, the method comprising the steps of:
validating Extensible Markup Language (XML) clinical data;
extracting data from the XML clinical data based on destination capabilities; and
translating the extracted data to conform to a non-XML standard.

18. The method of claim 17, wherein extracting data comprises extracting data from the XML clinical data based on destination capabilities to generate standard equivalent XML clinical data, and
wherein translating the extracted data comprises translating the standard equivalent XML clinical data to conform to a non-XML standard.

19. The method of claim 18, wherein extracting data comprises extracting data using an Extensible Stylesheet Language Transform (XLST) based on the destination capabilities.

20. The method of claim 17, wherein extracting data comprises extracting data based on a list of data elements provided by a database, the list of data elements based on the destination capabilities.

21. The method of claim 17, wherein translating the extracted data comprises translating the extracted data to Digital Imaging and Communications in Medicine (DICOM) conformant data.

22. The method of claim 17, wherein translating the extracted data comprises translating the extracted data to Health Level Seven (HL7) conformant data.

23. The method of claim 17, wherein validating the XML clinical data comprises validating the XML clinical data using XML schema validation.

24. The method of claim 17, further comprising the step of passing the non-XML standard data to a conformant data user.
